(19) United States
(12) Patent Application Publication
(10) Pub. No.: US 2016/0313660 A1
(43) Pub. Date: Oct. 27, 2016

(54) ELECTROSTATIC CHARGE IMAGE DEVELOPING TONER, ELECTROSTATIC CHARGE IMAGE DEVELOPER, AND TONER CARTRIDGE

(71) Applicant: FUJI XEROX CO., LTD., Tokyo (JP)

(72) Inventors: Erina SAITO, Kanagawa (JP); Noriyuki MIZUTANI, Kanagawa (JP); Daisuke ISHIZUKA, Kanagawa (JP); Kotaro YOSHIHARA, Kanagawa (JP); Yuki TAKAMIYA, Kanagawa (JP); Narumasa SATO, Kanagawa (JP); Yuka KAWAMOTO, Kanagawa (JP)

(21) Appl. No.: 15/199,079

(22) Filed: Jun. 30, 2016

Related U.S. Application Data
(62) Division of application No. 14/611,753, filed on Feb. 2, 2015.

(30) Foreign Application Priority Data
Sep. 8, 2014 (JP) 2014-182297

(51) Int. Cl. G03G 9/087; G03G 15/08

(52) U.S. Cl. CPC G03G 9/08711; G03G 9/08755; G03G 15/0865

(57) ABSTRACT

An electrostatic charge image developing toner includes toner particles containing a binder resin having a polyester resin and a styrene-(meth)acrylic acid alkyl copolymer resin, a release agent having a hydrocarbon release agent, and an oligomer which includes a styrene structure and whose content is in a range of 1% by weight to 6% by weight with respect to toner particles.

### CROSS-REFERENCE TO RELATED APPLICATIONS

This is a Division of application Ser. No. 14/611,753 filed Feb. 2, 2015, which claims the benefit of Japanese Patent Application No. 2014-182297 filed Sep. 8, 2014. The disclosure of the prior applications is hereby incorporated by reference herein in its entirety.

### BACKGROUND

### Technical Field

The present invention relates to an electrostatic charge image developing toner, an electrostatic charge image developer, and a toner cartridge.

### SUMMARY

According to an aspect of the invention, there is provided an electrostatic charge image developing toner including:

toner particles containing:

a binder resin having a polyester resin and a styrene-(meth)acrylic acid alkyl copolymer resin; a release agent having a hydrocarbon release agent; and an oligomer which includes a styrene structure and whose content is in a range of 1% by weight to 6% by weight with respect to toner particles.

### BRIEF DESCRIPTION OF THE DRAWINGS

Exemplary embodiments of the present invention will be described in detail based on the following figures, wherein:

FIG. 1 is a view schematically illustrating a configuration of an image forming apparatus according to the present exemplary embodiment;

FIG. 2 is a cross-sectional view schematically illustrating a fixing device of the image forming apparatus according to the present exemplary embodiment by partially enlarging the vicinity of the fixing device; and

FIG. 3 is a perspective view schematically illustrating the fixing device of the image forming apparatus according to the present exemplary embodiment.

### DETAILED DESCRIPTION

Hereinafter, exemplary embodiments which are examples of the present invention will be described in detail.

Electrostatic Charge Image Developing Toner

An electrostatic charge image developing toner according to the present exemplary embodiment (hereinafter, referred to as a “toner”) includes toner particles.

Further, the toner particles contain a binder resin including a polyester resin and a styrene-(meth)acrylic acid alkyl copolymer resin, a hydrocarbon release agent, and an oligomer having a styrene structure (hereinafter, referred to as a “styrene oligomer”). The content of the styrene oligomer is in the range of 1% by weight to 6% by weight with respect to toner particles.

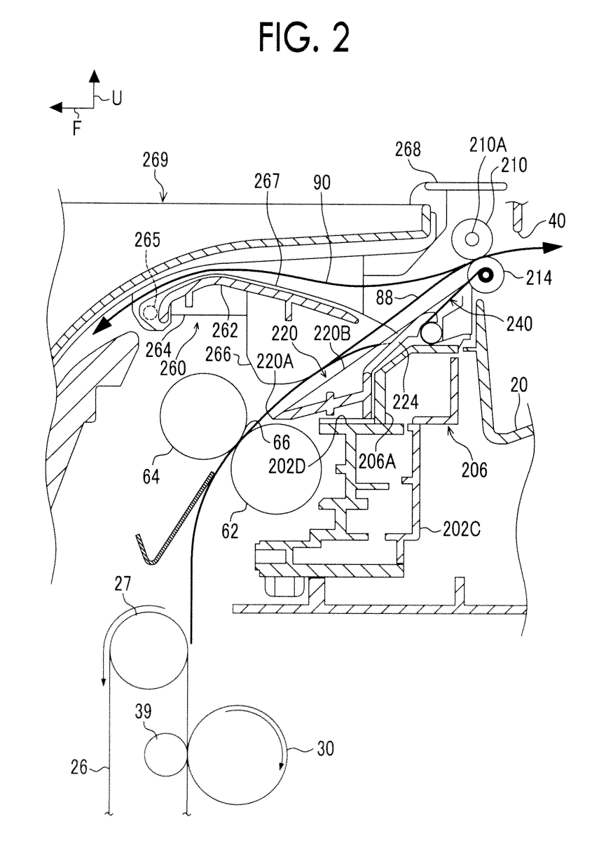

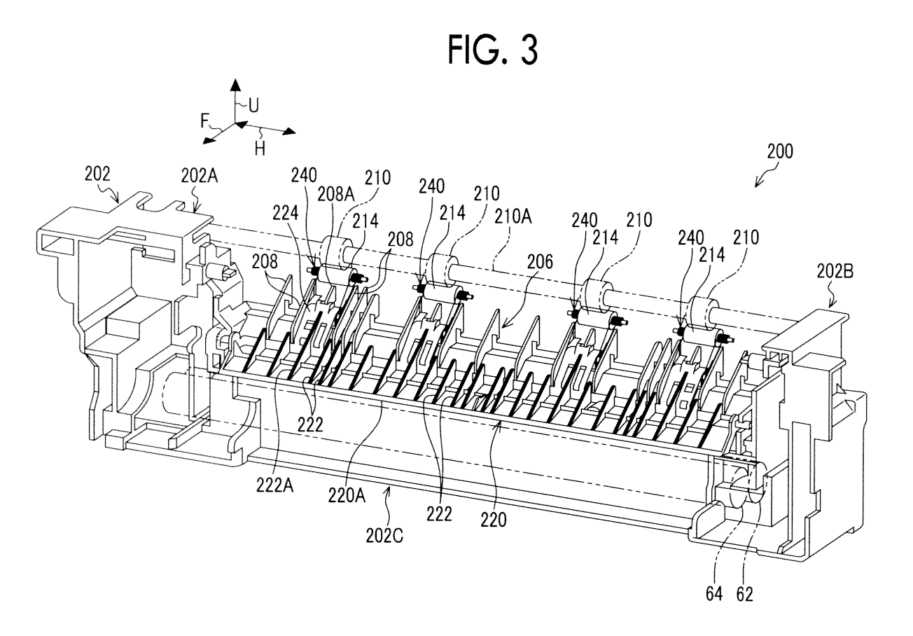

Here, a peeling property with respect to a fixing member increases and a gloss of an image may be obtained by a release agent oozing out on the surface of an image at the time of fixing when an image is formed by a toner using a release agent. In addition, a recording medium to which an image is fixed is guided by a guide member (for example, each rib of a peeling guide 220, each rib of a feeding path member 206, and a pinch roller 214 in a fixing device 200 illustrated in FIGS. 2 and 3) after passing through the fixing member and is discharged to the outside of an apparatus. The guide member guides the recording medium by being brought into contact with a portion of an image before completely cooled.

However, when the guide member is brought into contact with a portion of an image before completely cooled, a difference of a recrystallization speed of a release agent between the contact portion and the non-contact portion is generated because the contact portion is cooled faster than the non-contact portion. Specifically, the recrystallization speed of the contact portion becomes slow, and the recrystallization speed of the non-contact portion becomes fast. When a difference of the recrystallization speed of a release agent is partially generated, gloss unevenness of an image is generated in some cases.

Further, compatibility between the polyester resin and the styrene-(meth)acrylic acid alkyl copolymer resin is low and a release agent has low compatibility with both of these resins. Accordingly, in a case where a polyester resin and a styrene-(meth)acrylic acid alkyl copolymer resin are used as a binder resin, the release agent oozing out at the time of fixing tends to be unevenly distributed in the vicinity of a styrene-(meth)acrylic acid alkyl copolymer resin with hydrophobicity lower than that of a polyester resin.

Further, when the release agent is unevenly distributed and a difference of the recrystallization speed of the release agent is partially generated, the gloss unevenness of an image is more easily generated.

Meanwhile, in the toner according to the present exemplary embodiment, generation of gloss unevenness of an image (hereinafter, also simply referred to as “gloss unevenness of an image”) due to a contact with the guide member after the image is fixed is prevented by the above-described configuration. The reason therefor is not clear, but may be assumed as follows.

First, since a styrene oligomer has a styrene structure, the compatibility thereof with a hydrocarbon release agent having a hydrocarbon structure is high. The styrene oligomer becomes easily compatible with the hydrocarbon release agent when toner particles containing the styrene oligomer in the above-described amount together with the hydrocarbon release agent are melted at the time of fixing. Particularly, since the styrene oligomer is a low molecular substance, compatibility between the styrene oligomer and the hydrocarbon release agent is rapidly realized. Further, when the styrene oligomer is compatible with the hydrocarbon release agent, recrystallization of the release agent is easily inhibited. It is considered that when the guide member is brought into contact with a portion of an image, rapid cooling of the contact portion and thus slowdown of the recrystallization speed are prevented by the styrene oligomer being compatible with the hydrocarbon release agent because the crystallization speed of the styrene oligomer is slower than that of the hydrocarbon release agent.

In addition, when the recrystallization of the hydrocarbon release agent becomes easily inhibited, partial generation of the difference in recrystallization speed of the release agent is prevented.

Further, when toner particles including a polyester resin and a styrene-(meth)acrylic acid alkyl copolymer resin as a binder resin contains a styrene oligomer, the styrene-(meth)acrylic acid alkyl copolymer resin functions as a dispersant and the dispersibility of the styrene oligomer is improved. Therefore, a function of inhibiting recrystallization of the hydrocarbon release agent becomes easily exhibited.

As described above, with the toner according to the present exemplary embodiment, generation of the gloss unevenness of an image due to a contact with the guide member after the image is fixed is prevented.

Further, the gloss unevenness of an image is easily generated when a solid image (image in which the texture of the recording medium is not visually recognized) having an image area ratio of 100% is formed on coated paper (paper obtained by coating the surface of the paper with a coating material or a synthetic resin) serving as a recording medium in a low temperature and low humidity environment (for example, in an environment at 10° C. and at 15% RH). With the toner according to the present exemplary embodiment, generation of gloss unevenness of an image is prevented even when a solid image is formed in coated paper.

Moreover, in order to prevent the gloss unevenness of an image, a mode in which a guide member is not used or a guide member being in contact with the entire image is used is effective, but the weight or the size of an apparatus may be easily increased. However, with the toner according to the present exemplary embodiment, generation of the gloss unevenness of an image is prevented without employing the above-described modes.

Hereinafter, the toner according to the present exemplary embodiment will be described in detail.

The toner according to the present exemplary embodiment includes toner particles and an external additive if necessary.

Toner Particles

Toner particles include a binder resin, a release agent, and a styrene oligomer. The toner particles may include a colorant, a release agent, and other additives if necessary.

Binder Resin

As a binder resin, a polyester resin or a styrene-(meth)acrylic acid alkyl copolymer resin may be used.

A polyester resin will be described.

As an example of a polyester resin, a known polyester resin may be exemplified.

Examples of the polyester resin include a polycondensate between a polyvalent carboxylic acid and polyol. Further, as the polyester resin, a commercially available product or a synthesized product may be used.

Examples of the polyvalent carboxylic acid include an aliphatic dicarboxylic acid (for example, oxalic acid, malonic acid, maleic acid, fumaric acid, citraconic acid, itanonic acid, glutaconic acid, succinic acid, alkenyl succinic acid, adipic acid, or sebacic acid), alicyclic dicarboxylic acid (for example, cyclohexane dicarboxylic acid), aromatic dicarboxylic acid (for example, terephthalic acid, isophthalic acid, phthalic acid, or naphthalene dicarboxylic acid), an anhydride thereof, and lower (for example, the number of carbon atoms is in the range of 1 to 5) alkyl ester thereof. Among these, aromatic dicarboxylic acid is preferable as polyvalent carboxylic acid.

As the polyvalent carboxylic acid, a tri- or higher valent carboxylic acid having a cross-linked structure or a branched structure may be used together with dicarboxylic acid. Examples of tri- or higher valent carboxylic acid include trimellitic acid, pyromellitic acid, an anhydride thereof and lower (for example, the number of carbon atoms is in the range of 1 to 5) alkyl ester thereof.

Polyvalent carboxylic acid may be used alone or in combination of two or more kinds thereof.

Examples of the polyol include an aliphatic diol (for example, ethylene glycol, diethylene glycol, triethylene glycol, propylene glycol, butanediol, hexanediol, or neopentyl glycol), an alicyclic diol (for example, cyclohexanediol, cyclohexane dimethanol, or hydrogenated bisphenol A), and an aromatic diol (for example, an ethylene oxide adduct of bisphenol A or propylene oxide adduct of bisphenol A). Among these, as the polyol, an aromatic diol or an alicyclic diol is preferable and aromatic diol is more preferable.

As the polyol, tri- or higher valent polyol having a cross-linked structure or a branched structure may be used together with a diol. Examples of the tri- or higher valent polyol include glycerin, trimethylol propane, and pentaerythritol.

The polyol may be used alone or in combination of two or more kinds thereof.

The glass transition temperature (Tg) of the polyester resin is preferably in the range of 50° C. to 80° C. and more preferably in the range of 50° C. to 65° C.

In addition, the glass transition temperature is determined using a DSC curve obtained by differential scanning calorimetry (DSC) and, more specifically, the glass transition temperature is determined based on “the extrapolated glass transition starting temperature” described in a method of determining the glass transition temperature, JIS K-1987 “Testing Methods for Transition Temperatures of Plastics.”

The weight average molecular weight (Mw) of the polyester resin is preferably in the range of 5000 to 1000000, more preferably in the range of 7000 to 500000.

The number average molecular weight (Mn) of the polyester resin is preferably in the range of 2000 to 100000.

The molecular weight distribution Mw/Mn of the polyester resin is preferably in the range of 1.5 to 100 and more preferably in the range of 2 to 60.

Further, the weight average molecular weight and the number average molecular weight are measured by a gel permeation chromatography (GPC). Measurement of the molecular weight using GPC is performed in a THF solvent using HLC-8120 (GPC manufactured by Tosoh Corporation) as a measuring device and TSKgel SuperHM-M (15 cm) (column manufactured by Tosoh Corporation). The weight average molecular weight and the number average molecular weight are calculated using a molecular weight calibration curve created by a monodisperse polystyrene standard sample from the measurement results.

The polyester resin may be obtained by a known production method. Specifically, the polyester resin may be obtained by a method in which a polymerization temperature is set to 180° C. to 230° C., and a reaction is performed by reducing the pressure in a reaction system according to the necessity, and then removing water or alcohol generated during condensation.

In a case where a monomer of a raw material is not dissolved or compatible at the reaction temperature, the monomer may be dissolved by adding a solvent having a high boiling point as a solubilizing agent. In this case, the polycondensation reaction is performed while the solubilizing agent is distilled. In a case where a monomer with poor compatibility is present in the polycondensation reaction, the monomer with poor compatibility and acids or alcohol to be polycondensed with the monomer is polycondensed in advance, and then polycondensation with the main component may be performed.

The styrene-(meth)acrylic acid alkyl copolymer resin will be described.

Examples of the styrene-(meth)acrylic acid alkyl copolymer resin include a copolymer obtained by copolymerizing at least a styrene monomer and (meth)acrylic acid alkyl ester. Further, the styrene-(meth)acrylic acid alkyl copolymer resin may be a copolymer obtained by copolymerizing other monomers other than a styrene monomer and (meth)acrylic acid alkyl ester.

Here, the term “(meth)acryl” may express both of “acryl” and “methacryl”.

The styrene monomer is a monomer having a styrene structure. Examples of the styrene monomer include styrene; vinyl naphthalene; alkyl-substituted styrene such as α-methyl styrene, o-methyl styrene, m-methyl styrene, p-methyl styrene, p-ethyl styrene, 2,4-dimethyl styrene, p-n-butyl styrene, p-tert-butyl styrene, p-n-hexyl styrene, p-n-octyl styrene, p-n-nonyl styrene, p-n-decyl styrene, or p-n-dodecyl styrene; aryl-substituted styrene such as p-phenyl styrene; alkoxy-substituted styrene such as p-methoxy styrene; halogen-substituted styrene such as p-chlorostyrene, 3,4-dicholorostyrene, 4-fluorostyrene, or 2,5-difluorostyrene; and nitro-substituted styrene such as m-nitrostyrene, o-nitrostyrene, or p-nitrostyrene. Among these, as the styrene monomer, styrene, p-ethyl styrene, or p-n-butyl styrene is preferable.

These styrene monomers may be used alone or in combination of two or more kinds thereof.

The (meth)acrylic acid alkyl ester is a monomer which has a (meth)acryloyl group and in which an alkyl group is ester-bonded to (meth)acrylic acid. Specific examples of (meth)acrylic acid alkyl ester include (meth)acrylic acid alkyl ester such as n-methyl(meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-docecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, octyl (meth)acrylate, decyl (meth)acrylate, lauryl (meth)acrylate, stearyl (meth)acrylate, cyclohexyl (meth)acrylate, dicyclopentanyl (meth)acrylate, or isobornyl (meth)acrylate; di(meth)acrylic acid ester such as ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, or decanediol di(meth)acrylate; (meth)acrylic acid carboxy-substituted alkyl ester such as β-carboxy ethyl (meth)acrylate; (meth)acrylic acid hydroxy-substituted alkyl ester such as 2-hydroxy ethyl (meth)acrylate, 2-hydroxy propyl (meth)acrylate, 3-hydroxy propyl (meth)acrylate, 2-hydroxy butyl (meth)acrylate, 3-hydroxy butyl (meth)acrylate, or 4-hydroxy butyl (meth)acrylate; and (meth)acrylic acid alkoxy-substituted alkyl ester such as 2-methoxy ethyl (meth)acrylate.

Among these (meth)acrylic acid alkyl esters, (meth)acrylic acid alkyl ester including an alkyl group having 2 to 14 carbon atoms (preferably in the range of 2 to 10 carbon atoms and more preferably in the range of 3 to 8 carbon atoms) is preferable in terms of the fixing property.

As the (meth)acrylic acid alkyl ester, (meth)acrylic acid may be exemplified in addition to the above-described (meth)acrylic acid esters.

These (meth)acrylic acid alkyl esters may be used alone or in combination of two or more kinds thereof.

Examples of other monomers include ethylenically unsaturated nitriles (acrylonitrile and methacrylonitrile), vinyl ethers (vinyl methyl ether and vinyl isobutyl ether), vinyl ketones (vinyl methyl ketone, vinyl ethyl ketone, and vinyl isopropenyl ketone), divinyls (divinyl adipate and the like), and olefins (ethylene, propylene, and butadiene).

In the styrene-(meth)) acrylic acid alkyl copolymer resin, a ratio of styrene monomers to the whole polymerization components (that is, a ratio of a repeating unit derived from a styrene monomer to the total weight of the resin) may be 60% by weight or more, is preferably in the range of 65% by weight to 90% by weight, and more preferably in the range of 70% by weight to 85% by weight in terms of image storability.

Moreover, a ratio of (meth)acrylic acid alkyl ester to the whole polymerization components (that is, a ratio of a repeating unit derived from (meth)acrylic acid alkyl ester to the total weight of the resin) is preferably in the range of 10% by weight to 40% by weight and more preferably in the range of 10% by weight to 35% by weight.

The glass transition temperature (Tg) of the styrene-(meth)acrylic acid alkyl copolymer resin is preferably in the range of 40° C. to 70° C. and more preferably in the range of 50° C. to 65° C. in terms of excellent powder characteristics of the toner.

Further, the glass transition temperature is measured in the same manner as the glass transition temperature of a polyester resin.

The weight average molecular weight (Mw) of the styrene-(meth)acrylic acid alkyl copolymer resin is preferably in the range of 20000 to 200000 and more preferably in the range of 40000 to 100000 in terms of excellent powder characteristics of the toner.

The number average molecular weight (Mn) of the styrene-(meth)acrylic acid alkyl copolymer resin is preferably in the range of 5000 to 30000.

The molecular weight distribution Mw/Mn of the styrene-(meth)acrylic acid alkyl copolymer resin is preferably in the range of 1 to 10 and more preferably in the range of 2 to 6.

The weight average molecular weight and the number average molecular weight are measured in the same manner as the molecular weight of a polyester resin.

A known polymerization method (radical polymerization methods such as an emulsion polymerization method, a soap free emulsion polymerization, suspension polymerization, miniemulsion polymerization, and microemulsion polymerization) is used for synthesizing the styrene-(meth)acrylic acid copolymer resin.

Further, during polymerization, the crosslinking density of the styrene-(meth)acrylic acid alkyl copolymer resin may be controlled by controlling the amount of a crosslinking agent (for example, decanediol acrylate).

Other binder resins will be described.

The binder resins may include other resins other than a polyester resin and a styrene-(meth)acrylic acid alkyl copolymer resin. In this case, a ratio of the polyester resin and the styrene-(meth)acrylic acid alkyl copolymer resin occupied in the entire binder resin may be 55% by weight or more (preferably 70% by weight or more and more preferably 90% by weight or more).

Examples of other binder resins include a vinyl resin other than the styrene-(meth)acrylic acid alkyl copolymer resin (for example, a styrene resin or an acrylic acid alkyl resin) and a non-vinyl resin (for example, an epoxy resin, a polyurethane resin, a polyamide resin, a cellulose resin, a polyether resin, or a modified rosin).

The content of the binder resin will be described.

The content of the binder resin is preferably in the range of 40% by weight to 95% by weight, more preferably in the range of 50% by weight to 90% by weight, and still more preferably in the range of 60% by weight to 90% by weight with respect to the entirety of toner particles.

Here, the content of the polyester resin is in the range of 50% by weight to 95% by weight (preferably in the range of 60% by weight to 80% by weight) with respect to the entirety of the binder resin in terms of the fixing property.

The content of the styrene-(meth)acrylic acid alkyl copolymer resin may be in the range of 5% by weight to 50% by weight (preferably in the range of 5% by weight to 30% by weight) with respect to the entirety of the binder resin in terms of achieving both of the fixing property and the charging property. Particularly, when the content of the styrene-(meth)acrylic acid alkyl copolymer resin is adjusted to be in the range of 5% by weight to 30% by weight (preferably in the range of 10% by weight to 30% by weight), the dispersibility of the styrene oligomer is improved and generation of gloss unevenness of an image becomes easily prevented. Further, the charging property of the toner is improved.

Release Agent

As the release agent, a hydrocarbon release agent is used.

The hydrocarbon release agent is a wax having hydrocarbon as a structure. Examples of the hydrocarbon release agent include a Fischer-Tropsch wax, a polyethylene wax (wax having a polyethylene structure), a polypropylene wax (wax having a polypropylene structure), a paraffin wax (was having a paraffin structure), and a microcrystalline wax.

The hydrocarbon release agent has an endothermic peak measured by differential scanning calorimetry, which undergoes a first temperature rise and fall and a second temperature rise, and may preferably have a maximum endothermic peak (hereinafter, also referred to as a “maximum second endothermic peak”) measured at the second temperature rise in a temperature range of 80° C. to 120° C. (preferably in the range of 90° C. to 110° C.). Further, the expression of “having the maximum endothermic peak” means having a peak with a height of 0.2 mW or higher from a reference temperature range, which becomes the baseline, of 70° C. to 130° C.

When the maximum second peak of the hydrocarbon release agent is in the above-described range, the compatibility with the styrene oligomer is more increased so that the gloss unevenness of an image becomes easily prevented.

Moreover, the maximum second peak of the hydrocarbon release agent is a maximum endothermic peak measured by (1) performing heating from room temperature (25° C.) to 150° C. at a temperature rising rate of 10° C./min as the first temperature rise, (2) holding the state at 150° C. for 5 minutes, (3) performing cooling from 150° C. to 0° C. at a temperature falling rate of 10° C./min as the first temperature fall, (4) holding the state at 0° C. for 5 minutes, and (5) performing heating from 0° C. to 150° C. at a temperature rising rate of 10° C./min using a differential scanning calorimeter (“DSC-60 type,” manufactured by Shimadzu Corporation).

The release agent may include another release agent other than the hydrocarbon release agent. In this case, a ratio of the hydrocarbon release agent with respect to the entirety of the release agent may be 85% by weight or more (preferably in the range of 95% by weight or more).

Examples of another release agent include natural waxes such as a carnauba wax, a rice wax, and a candelilla wax; synthetic or mineral and petroleum waxes such as a montan wax; and ester waxes such as fatty acid ester and montan acid ester.

The content of the release agent is preferably in the range of 1% by weight to 20% by weight and more preferably in the range of 3% by weight to 15% by weight with respect to the entirety of the toner particles.

Styrene Oligomer

The styrene oligomer is an oligomer having a styrene structure. The styrene oligomer is, for example, an oligomer obtained by polymerizing a monomer at a degree of polymerization of 2 to 100. Examples of the styrene oligomer include an oligomer obtained by homopolymerizing a monomer having a styrene structure and an oligomer obtained by copolymerizing a monomer having a styrene structure and another monomer.

As the styrene oligomer, the oligomer obtained by homopolymerizing a monomer having a styrene structure is preferable in terms of increasing compatibility with a hydrocarbon release agent and preventing gloss unevenness of an image.

Moreover, in a case of the oligomer obtained by copolymerizing a monomer having a styrene structure and another monomer, the oligomer may contain components derived from a monomer having a styrene structure in an amount of 50% by weight or more (preferably 70% by weight and more preferably 90% by weight or more) with respect to the whole components.

As the monomer having a styrene structure, a compound represented by the following formula (St) is exemplified.

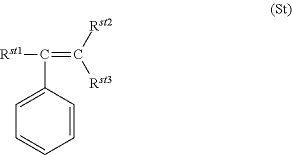

In the formula (St), R^{st1} represents a hydrogen atom, an alkyl group, an aryl group, or an allyl group.

R^{st2} represents a hydrogen atom, an alkyl group, an aryl group, or an allyl group.

R^{st3} represents a hydrogen atom, an alkyl group, an aryl group, or an allyl group.

As an example of the alkyl group represented by R^{st1}, R^{st2}, or R^{st3}, an alkyl group which is linear, branched, or cyclic (preferably linear or branched) and has 1 to 20 carbon atoms (preferably 1 to 10 carbon atoms) may be exemplified. Examples of the alkyl group include a substituted alkyl group which is substituted with an aryl group such as a phenyl group.

Examples of the aryl group represented by R^{st1}, R^{st2}, or R^{st3} include a phenyl group, a benzyl group, and a tolyl group. Examples of the aryl group include a substituted aryl group which is substituted with an alkyl group or the like.

Particularly, as the compound represented by the formula (St), a compound in which R^{st1} represents a hydrogen atom, a methyl group, or an ethyl group, R^{st2} represents a hydrogen atom, a methyl group, or an ethyl group, and R^{st3} represents a hydrogen atom, a methyl group, or an ethyl group is preferable.

Examples of the monomer having a styrene structure include 2,4-diphenyl-1-butene and 2,4,6-triphenyl-1-hexene.

Examples of another monomer which may be copolymerized with the monomer having a styrene structure include (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (acrylonitrile and methacrylonitrile), vinyl ethers (vinyl methyl ether and vinyl isobutyl ether), vinyl ketones (vinyl methyl ketone, vinyl ethyl ketone, and vinyl isopropenyl ketone), and olefins (ethylene, propylene, and butadiene).

The styrene oligomer may include the maximum peak of the molecular weight distribution measured by gel filtration chromatogram in a range of a molecular weight of 200 to 8000 (preferably in the range of 200 to 2000). Further, the expression of “having the maximum peak” means having a peak with a height of 5 mV or smaller from a reference after setting a peak collection time of 0 minute to 15 minutes as the reference.

When the peak of the molecular weight distribution of the styrene oligomer is in the above-described range, the compatibility with the hydrocarbon release agent is more increased so that the gloss unevenness of an image becomes easily prevented.

The weight average molecular weight Mw of the styrene oligomer measured by gel filtration chromatogram is preferably in the range of 200 to 5000 and more preferably in the range of 200 to 1500.

When the weight average molecular weight Mw of the styrene oligomer is in the above-described range, the compatibility with the hydrocarbon release agent is more increased so that the gloss unevenness of an image becomes easily prevented.

Further, a peak of the molecular weight distribution and the weight average molecular weight measured by gel filtration chromatogram are measured by the following methods.

Gel filtration chromatogram device: manufactured by Tosoh Corporation; HLC-8220GPC, column: manufactured by Tosoh Corporation; Tsk gel Super HZM-H (6.0 mm×150 mm), 2 reams, measurement temperature: 40° C. (column, detector), solvent: tetrahydrofuran (THF), flow rate: 0.6 mL/min, detector: RI (differential refractometer), sample concentration: 0.2% (concentration as soluble elements), injection amount of sample: 10 μL, pre-treatment on sample: a sample is dissolved in THF, filtered using a syringe filter having a size of 0.45 μm and having solvent resistance, and then set as a measurement sample. Calibration curve: created using a standard polystyrene resin.

The styrene oligomer may contain carbon and hydrogen in an amount of 95 atomic % (preferably in the range of 98 atomic % to 100 atomic %) with respect to the whole constituent elements.

When the content ratio of carbon and hydrogen (content ratio of C and H) in the styrene oligomer is in the above-described range, the compatibility with the hydrocarbon release agent is more increased so that the gloss unevenness of an image becomes easily prevented.

Further, the content ratio of carbon and hydrogen in the styrene oligomer is measured as follows.

Toner particles are dissolved in a solution such as methanol, ultrasonic waves are applied to the solvent, and a styrene oligomer-containing liquid is extracted. The extracted styrene oligomer-containing liquid is subjected to a liquid chromatograph and the styrene oligomer is separated and fractionated. Further, the sample of the fractionated styrene oligomer is specified by chromatographic analysis using a TCD detector. Hydrogen, carbon, and nitrogen gas generated from the sample burned in a reactor are separated from one another using the column, and the quantity is determined from the peak area. As the standard substance, acetanilide is used. In this manner, the content ratio of carbon and hydrogen is determined.

The content of the styrene oligomer is in the range of 1% by weight to 6% by weight with respect to the toner particles, and is preferably in the range of 2% by weight to 5% by weight and more preferably in the range of 3% by weight to 4% by weight in terms of preventing gloss unevenness of an image.

The content of the styrene oligomer is measured by a method described below.

Toner particles are dissolved in a solution such as methanol, ultrasonic waves are applied to the solvent, and a styrene oligomer-containing liquid is extracted. The extracted styrene oligomer-containing liquid is subjected to a liquid chromatograph and the styrene oligomer is separated and fractionated. Further, a calibration curve is created by performing the above-described operation using toner particles whose content of the styrene oligomer is known. The content of the styrene oligomer in toner particles is determined by performing the same operation based on the calibration curve.

The conditions of the liquid chromatograph when the content ratio of carbon and hydrogen and the content of the styrene oligomer are measured are as follows.

“HPLC ELITE LaChrom L-2000 series (Hitachi High-Technologies Corporation)” is used as an analysis device. “Inertsil ODS3 (5 μm) φ4.6×250 mm (GL Sciences, Inc.)” is used as a column and “0.1 vol % phosphoric acid/acetonitrile=20/80” is used as an eluent. The analysis time is 90 minutes (the range of 0 minute to 35 minutes for which main peaks are detected is analyzed and the column is washed for 35 minutes to 90 minutes for completely taking polymer components out, the injection amount of the sample is 10 μL, and the measurement wavelength is set as 210 mm.

—Colorants—

Examples of colorants include various pigments such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Du Pont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and various dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenylmethane dye, a diphenylmethane dye, and a thiazole dye.

These colorants may be used alone or in combination of two or more kinds thereof.

As the colorant, a colorant subjected to a surface treatment may be used according to the necessity or a combination with a dispersant may be used. In addition, the colorants may be used in combination of plural kinds thereof.

The content of the colorant is preferably in the range of 1% by weight to 30% by weight and more preferably in the range of 3% by weight to 15% by weight with respect to the entirety of toner particles.

—Other Additives—

Examples of other additives include known additives such as a magnetic material, a charge-controlling agent, and inorganic powders. These additives are contained in toner particles as internal additives.

—Characteristics of Toner Particles—

The toner particles may have a single layer structure or a so-called core-shell structure formed of a core (core particles) and a coating layer (shell layer) covering the core.

Here, the toner particles having a core-shell structure may be formed of a core containing a binder resin and other additives such as a coloring agent and a release agent according to the necessity; and a coating layer containing a binder resin.

In addition, the (meth)acrylic acid alkyl ester is contained at least one of the core and the coating portion.

The volume average particle diameter (D50v) of the toner particles is preferably in the range of 2 μm to 15 μm and more preferably in the range of 3 μm to 9 μm.

In addition, various average particle diameters and various particle size distribution indices of toner particles are measured using Coulter Multisizer-II (manufactured by BECKMAN COULTER) and as an electrolyte solution, ISOTON-II (manufactured by BECKMAN COULTER) is used.

During the measurement, a measurement sample is added to 2 mL of a 5% aqueous solution of a surfactant (sodium alkylbenzene sulfonate is preferable) as a dispersant, in an amount of 0.5 mg to 50 mg. The obtained solution is added to 100 mL to 150 mL of an electrolyte solution.

The electrolyte in which the sample is suspended is subjected to a dispersion treatment in an ultrasonic disperser for 1 minute, and the particle size distribution of particles having a particle diameter in the range of 2 μm to 60 μm is measured using an aperture having an aperture diameter of 100 μm with Coulter Multisizer-II. Further, the number of particles for sampling is 50000.

Cumulative distributions of the volume and the number are drawn from the small diameter side with respect to the particle size range (channel) divided based on the measured particle size distribution, and the particle diameter corresponding to 16% cumulation is defined as a volume particle diameter D16v and a number particle diameter D16p, the particle diameter corresponding to 50% cumulation is defined as a volume average particle diameter D50v and a cumulative number average particle diameter D50p, and the particle diameter corresponding to 84% cumulation is defined as a volume particle diameter D84v and a number particle diameter D84p.

Using these definitions, the volume average particle size distribution index (GSDv) is calculated as (D84v/D16v)^{1/2} and the number average particle size distribution index (GSDp) is calculated as (D84p/D16p)^{1/2}.

A shape factor SF1 of the toner particles is preferably in the range of 110 to 150 and more preferably in the range of 120 to 140.

In addition, the shape factor SF1 is determined by the following equation.

SF1=(ML²/A)λ(π/4)×100 Equation

In the equation, ML represents a maximum absolute length of a toner and A represents a projected area of a toner.

Specifically, the shape factor SF1 is digitized by mainly analyzing a microscope image or a scanning electron microscope (SEM) image using an image analyzer and is calculated as follows. That is, an optical microscope image of particles sprayed on the surface of slide glass is captured in an image analyzer (Luzex) by a video camera, the maximum length and the projected area of one hundred particles are determined, and calculation is performed using the above equation, and then the average value thereof is determined, thereby obtaining the shape factor.

External Additives. As the external additive, inorganic particles are exemplified. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surface of inorganic particles as an external additive may be subjected to a treatment with a hydrophobizing agent. The treatment is performed by dipping the inorganic particles in a hydrophobizing agent. The hydrophobizing agent is not particularly limited, and examples thereof include a silane coupling agent, silicone oil, a titanate coupling agent, and an aluminum coupling agent. These may be used alone or in combination of two or more kinds thereof.

The amount of the hydrophobizing agent is generally in the range of 1 part by weight to 10 parts by weight with respect to 100 parts by weight of the inorganic particles, for example.

Examples of the external additive include resin particles (resin particles such as polystyrene, PMMA, and a melamine resin) and cleaning activators (for example, metal salts of higher fatty acids represented by zinc stearate and particles of a fluorine polymer).

The amount of the external additive is preferably in the range of 0.01% by weight to 5% by weight and more preferably in the range of 0.01% by weight to 2.0% by weight with respect to toner particles, for example.

Method of Preparing Toner

Next, a method of preparing a toner according to the present exemplary embodiment will be described.

The toner according to the present exemplary embodiment may be obtained by adding an external additive to toner particles after the toner particles are prepared.

The toner particles may be prepared using a dry method (for example, a kneading and pulverizing method) or a wet method (for example, an aggregation and coalescence method, a suspension polymerization method, or a dissolution suspension method). The method of preparing toner particles is not particularly limited, and a known method is employed.

Among these, the toner particles may preferably be obtained using an aggregation and coalescence method.

Specifically, for example, in the case where toner particles are prepared using the aggregation and coalescence method, toner particles are prepared by performing a process of preparing a resin particle dispersion in which resin particles, which become a binder resin, are dispersed (resin particle dispersion preparation process); a process of aggregating resin particles (other particles according to the necessity) in the resin particle dispersion (in a dispersion after mixing other particle dispersion according to the necessity) and forming aggregated particles (aggregated particles forming process); and a process of heating the aggregated particle dispersion in which aggregated particles are dispersed, coalescing the aggregated particles, and forming toner particles (coalescence process).

Here, in the aggregation and coalescence method, the styrene oligomer is added to a dispersion during at least one process among the above-described processes. Further, in a case where toner particles having a core-shell structure described below are prepared, the styrene oligomer may be added to each dispersion after the aggregated particle dispersion in which aggregated particles are dispersed is obtained.

In addition, the conditions of synthesizing the styrene-(meth)acrylic acid alkyl copolymer resin as a binder resin are changed to form a styrene oligomer, and a styrene-(meth)acrylic acid alkyl copolymer resin containing a styrene oligomer may be used.

Hereinafter, details of respective processes will be described.

In the description below, a method of obtaining toner particles containing a colorant and a release agent will be described, but the colorant and the release agent are used according to the necessity. Instead of the colorant and the release agent, other additives may be used.

Resin Particle Dispersion Preparation Process

First, for example, a colorant particle dispersion in which colorant particles are dispersed and a release agent particle dispersion in which release agent particles are dispersed are prepared together with the resin particle dispersion in which resin particles which become a binder resin are dispersed.

Here, the resin particle dispersion is prepared by dispersing resin particles in a dispersion medium using a surfactant.

As a dispersion medium used for the resin particle dispersion, an aqueous medium may be exemplified.

Examples of the aqueous medium include water such as distilled water or ion exchange water, and alcohol. They may be used alone or in combination of two or more kinds thereof.

Examples of the surfactant include anionic surfactants such as a sulfate ester salt surfactant, a sulfonate surfactant, a phosphate ester surfactant, and a soap surfactant; cationic surfactants such as an amine salt surfactant and a quaternary ammonium salt surfactant; and non-ionic surfactants such as a polyethylene glycol surfactant, an alkyl phenol ethylene oxide adduct surfactant, and a polyol surfactant. Particularly, among these, anionic surfactants and cationic surfactants may be exemplified. The non-ionic surfactants may be used in combination with anionic surfactants or cationic surfactants.

The surfactants may be used alone or in combination of two or more kinds thereof.

In the resin particle dispersion, examples of the method of dispersing resin particles in a dispersion medium include general dispersion methods using a rotary shearing type homogenizer, and a ball mill, a sand mill, and a dynomill which have media. Further, resin particles may be dispersed in the resin particle dispersion using a phase inversion emulsification method depending on the kind of resin particles.

In addition, the phase inversion emulsification method is a method of dispersing a resin in an aqueous medium in a particle shape by dissolving a resin to be dispersed in a hydrophobic organic solvent in which the resin is soluble, adding a base to an organic continuous phase (0 phase) to be neutralized, and putting an aqueous medium (W phase) thereto such that the resin is converted (so-called phase inversion) from W/O to O/W to form a discontinuous phase.

The volume average particle diameter of the resin particles to be dispersed in the resin particle dispersion is preferably in the range of 0.01 μm to 1 μm, more preferably in the range of 0.08 μm to 0.8 μm, and still more preferably in the range of 0.1 μm to 0.6 μm.

Further, the volume average particle diameter of the resin particles is measured by drawing cumulative distribution of the volume from the small diameter side with respect to the particle size range (channel) divided based on the particle size distribution obtained by measurement using a laser diffraction particle size distribution measuring device (for example, LA-700, manufactured by Horiba, Ltd.) and defining the particle diameter corresponding to 50% cumulation with respect to the entirety of particles as a volume average particle diameter D50v. Further, the volume average particle diameters of particles in other dispersions are measured in the same manner.

The content of the resin particles contained in the resin particle dispersion is preferably in the range of 5% by weight to 50% by weight and more preferably in the range of 10% by weight to 40% by weight.

Moreover, in the same manner as the resin particle dispersion, for example, the colorant particle dispersion and the release agent particle dispersion are prepared. That is, in regard to the volume average particle diameter of particles, the dispersion medium, the dispersion method, and the content of the particles, the same as those for the resin particles in the resin particle dispersion is applied to colorant particles dispersed in the colorant particle dispersion and release agent particles dispersed in the release agent particle dispersion.

Aggregated Particle Forming Process

Next, the colorant particle dispersion and the release agent particle dispersion are mixed together with the resin particle dispersion.

Further, the resin particles, the colorant particles, and the release agent particles are hetero-aggregated in the mixed dispersion and aggregated particles having a diameter close to the diameter of target toner particles and including resin particles, colorant particles, and release agent particles are formed.

Specifically, for example, a coagulant is added to the mixed dispersion and the pH of the mixed dispersion is adjusted to be acidic (for example, the pH is in the range of 2 to 5), after a dispersion stabilizer is added thereto according to the necessity, the temperature of the dispersion is heated to the glass transition temperature of the resin particles (specifically, for example, from a temperature 30° C. lower than the glass transition temperature to a temperature 10° C. lower than the glass transition temperature of resin particles, the particles dispersed in the mixed dispersion are aggregated, and then aggregated particles are formed.

In the aggregated particle forming process, for example, the mixed dispersion is stirred by a rotary shearing type homogenizer, the above-described coagulant is added thereto at room temperature (for example, 25° C.), the pH of the mixed dispersion is adjusted to be acidic (for example, the pH is in the range of 2 to 5), a dispersion stabilizer is added thereto according to the necessity, and then the above-described heating may be performed.

Examples of the coagulant include a surfactant having an opposite polarity of a surfactant used as a dispersant to be added to the mixed dispersion, inorganic metal salts, and a divalent or higher metal complex. Particularly, in a case where a metal complex is used as a coagulant, the amount of a surfactant to be used is decreased and the charging characteristics are improved.

Further, an additive forming a complex or a bond similar thereto with the metal ions of the coagulant may be added according to the necessity. As the additive, a chelating agent is preferably used.

Examples of inorganic metal salts include metal salts such as calcium chloride, calcium nitrate, barium chloride, magnesium chloride, zinc chloride, aluminum chloride, and aluminum sulfate; and an inorganic metal salt polymer such as polyaluminum chloride, polyaluminum hydroxide, or calcium polysulfide.

As the chelating agent, a water-soluble chelating agent may be used. As the chelating agent, oxycarboxylic acid such as acidum tartaricum, citric acid, gluconic acid, iminodiacetic acid (IDA), nitrilotriacetic acid (NTA), and ethylenediaminetetraacetic acid (EDTA), or the like, for example, may be used.

The amount of the chelating agent to be added is preferably in the range of 0.01 parts by weight to 5.0 parts by weight and more preferably in the range of 0.1 parts by weight to less than 3.0 parts by weight with respect to 100 parts by weight of resin particles.

Coalescence Process

Next, the aggregated particle dispersion in which the aggregated particles are dispersed is heated at a temperature higher than or equal to the glass transition temperature of the resin particles (for example, at least a temperature 10° C. to 30° C. higher than the glass transition temperature of the resin particles), the aggregated particles are coalesced, and then toner particles are formed.

Toner particles are obtained by performing the above-described processes.

Further, toner particles may be prepared by performing a process of forming second aggregated particles by further mixing the aggregated particle dispersion and the resin particle dispersion in which resin particles are dispersed after the aggregated particle dispersion in which aggregated particles are dispersed is obtained, and aggregating the resin particles so as to be adhered to the surface of the aggregated particles; and a process of forming toner particles having a core-shell structure by heating a second aggregated particle dispersion in which the second aggregated particles are dispersed, and coalescing the second aggregated particles.

Here, after the coalescence process is completed, toner particles in a state of being dried are obtained by applying a known washing process, a solid-liquid separation process, and a drying process to toner particles formed in a solution.

In the washing process, preferably, displacement washing using ion exchange water may be sufficiently performed in terms of the charging property. Further, the solid-liquid separation process is not particularly limited, but suction filtration, pressure filtration, and the like may preferably be performed in terms of productivity. Moreover, the method of the drying process is not particularly limited, but freeze-drying, flash jet drying, fluidizing drying, vibration type fluidizing drying, and the like may preferably be performed in terms of productivity.

Further, the toner according to the present exemplary embodiment is prepared by adding an external additive to the obtained toner particles in a dry state and mixing the mixture. The mixing may be performed using a V blender, a Henschel mixer, or a Lödige mixer. Further, coarse particles of the toner may be removed using a vibration sieve or a wind classifier if necessary.

Electrostatic Charge Image Developer

An electrostatic charge image developer of the present exemplary embodiment contains at least the toner according to the present exemplary embodiment.

The electrostatic charge image developer according to the present exemplary embodiment may be a single-component developer containing only the toner according to the present exemplary embodiment or may be a two-component developer obtained by mixing the toner and a carrier.

The carrier is not particularly limited and known carriers may be exemplified. Examples of the carrier include a coated carrier in which the surface of a core made of magnetic powder is coated with a coating resin; a magnetic powder dispersion type carrier in which magnetic powder is dispersed and combined with a matrix resin; and a resin impregnation type carrier in which porous magnetic powder is impregnated with a resin.

Further, the magnetic powder dispersion type carrier and the resin impregnation type carrier may be carriers obtained by using constituent particles of the carrier as the core and coating the core with a coating resin.

Examples of the magnetic powder include magnetic metals such as iron, nickel, and cobalt; and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin having an organosiloxane bond or a modified product thereof, a fluorine resin, polyester, polycarbonate, a phenol resin, and an epoxy resin.

Further, other additives such as conductive particles may be contained in the coating resin and the matrix resin.

Examples of the conductive particles include particles of metals such as gold, silver, and copper, carbon black, titanium oxide, zinc oxide, tin oxide, barium sulfate, aluminum borate, and potassium titanate.

Examples of the method of coating the surface of a core with a coating resin include a method of coating the surface thereof with a solution for forming a coating layer obtained by dissolving a coating resin and various additives in an appropriate solvent according to the necessity. The solvent is not particularly limited and may be selected in consideration of a coating resin to be used, coating suitability, and the like.

Specific examples of the method of coating the surface with a resin include a dipping method of dipping a core in a solution for forming a coating layer; a spray method of spraying a solution for forming a coating layer to the surface of a core; a fluidized bed method of spraying a solution for forming a coating layer in a state in which a core is floated due to fluidized air; and a kneader coater method of mixing core of the carrier with a solution for forming a coating layer in a kneader coater and removing the solvent.

The mixing ratio (weight ratio) of the toner to the carrier (toner:carrier) in the two-component developer is preferably in the range of 1:100 to 30:100 and more preferably in the range of 3:100 to 20:100.

Image Forming Apparatus/Image Forming Method

An image forming apparatus and an image forming method according to the present exemplary embodiment will be described.

The image forming apparatus according to the present exemplary embodiment includes an image holding member; a charging unit that charges a surface of the image holding member; an electrostatic charge image forming unit that forms an electrostatic charge image on the surface of the charged image holding member; a developing unit that accommodates an electrostatic charge image developer and develops the electrostatic charge image formed on the surface of the image holding member as a toner image using the electrostatic charge image developer; a transfer unit that transfers the toner image formed on the surface of the image holding member to a surface of a recording medium; and a fixing unit that includes a fixing member fixing the toner image transferred to the surface of the recording medium and a guide unit including a guide member guiding the recording medium on which the toner image is fixed by contacting a portion of the toner image after fixing. In addition, the electrostatic charge image developer according to the present exemplary embodiment is applied as the electrostatic charge image developer.

In the image forming apparatus according to the present exemplary embodiment, an image forming method (image forming method according to the present exemplary embodiment) including a charging process of charging a surface of an image holding member; an electrostatic charge image forming process of forming an electrostatic charge image on the surface of the charged image holding member; a developing process of developing the electrostatic charge image formed on the surface of the image holding member as a toner image using the electrostatic charge image developer according to the present exemplary embodiment; a transfer process of transferring the toner image formed on the surface of the image holding member to a surface of a recording medium; and a fixing process of fixing the toner image transferred to the surface of the recording medium and guiding the recording medium on which the toner image is fixed by the guide member by contacting a portion of the toner image after fixing is performed.

Here, the distance which a recording medium travels, from the fixing member to the guide member, may be 1 m or less (preferably in the range of 0.02 m to 0.3 m). This is the distance along a feeding path of the recording medium from a point in which the contact between the recording medium and the fixing member is finished to a point in which the contact between the recording medium and the guide member is started. When the distance is 1 m or less, which is short, the image after fixing is not completely cooled so that the gloss unevenness of the image is easily generated. Particularly, when the guide member is a roll member, the gloss unevenness of the image becomes significant because the contact area with the image is large compared to that of a rib member. Meanwhile, in the present exemplary embodiment, the generation of the gloss unevenness of the image is prevented even in a state in which the gloss unevenness of an image is easily generated.

Examples of the image forming apparatus according to the present exemplary embodiment include known image forming apparatuses such as an apparatus having a direct transfer system of directly transferring a toner image formed on a surface of an image holding member to a recording medium; an apparatus having an intermediate transfer system of primarily transferring a toner image formed on a surface of an image holding member to a surface of an intermediate transfer member and then secondarily transferring the toner image transferred to the surface of the intermediate transfer member to a surface of a recording medium; an apparatus including a cleaning unit that performs cleaning of a surface of an image holding member after transferring a toner image and before charging; and an apparatus including an erasing unit that performs erasing by irradiating a surface of an image holding member with erasing light after transferring a toner image and before charging.

In the case of the apparatus having an intermediate transfer system, the transfer unit has a configuration including an intermediate transfer member to a surface of which a toner image is transferred; a primary transfer unit that primarily transfers the toner image formed on a surface of an image holding member to the surface of the intermediate transfer member; and a secondary transfer unit that secondarily transfers the toner image transferred to the surface of the intermediate transfer member to the surface of the recording medium.

In addition, in the image forming apparatus according to the present exemplary embodiment, a portion including the developing unit may have a cartridge structure (process cartridge) which is detachable from the image forming apparatus. As the process cartridge, a process cartridge including the developing unit accommodating the electrostatic charge image developer according to the present exemplary embodiment is preferably used.

Hereinafter, an example of the image forming apparatus according to the present exemplary embodiment will be described, but the present invention is not limited thereto. In addition, main elements illustrated in the figures are described and description of other elements is omitted.

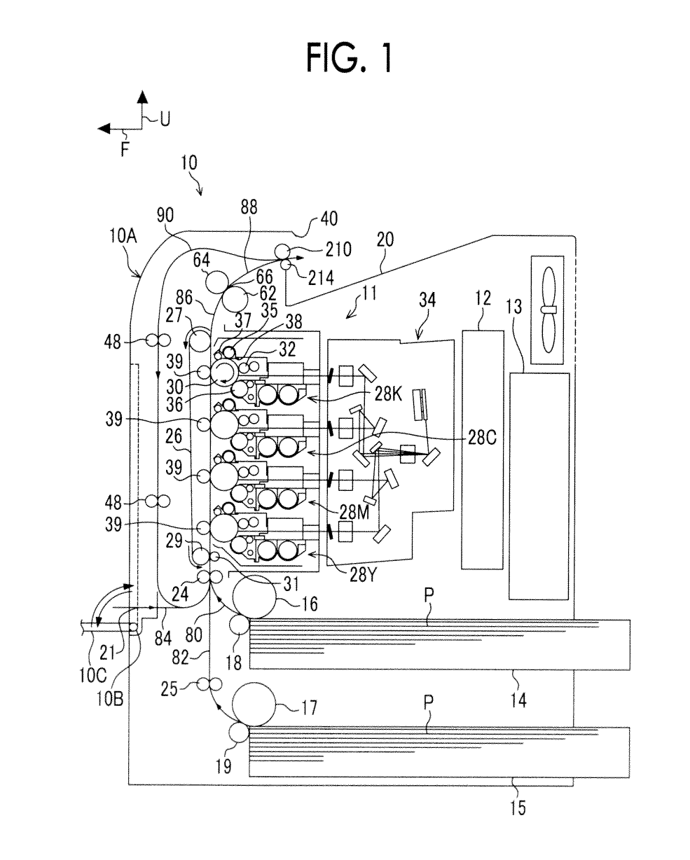

FIG. 1 is a view schematically illustrating a configuration of an image forming apparatus according to the present exemplary embodiment. FIG. 2 is a cross-sectional view schematically illustrating a fixing device of the image forming apparatus according to the present exemplary embodiment by partially enlarging the vicinity of the fixing device. FIG. 3 is a perspective view schematically illustrating the fixing device of the image forming apparatus according to the present exemplary embodiment.

An image forming apparatus 10 illustrated in FIG. 1 includes sheet feed containers 14 and 15 in which sheet P (an example of a recording medium) is laminated in a bundle and accommodated in the lower portion of the apparatus; and a sheet discharge portion 20 that arranges the sheet P discharged to the outside from a discharge port 40, on which an image is formed, on the upper portion thereof. Further, the image forming apparatus 10 includes an image forming unit 11 that forms an image on the sheet P; a control unit 12 that controls an operation of forming an image; and a power source unit 13 between the sheet feed containers 14 and 15 and the sheet discharge unit 20. Further, the image forming apparatus 10 includes plural sheet feeding paths that guides the sheet P to each of image forming processes of the apparatus and plural feeding rollers that are provided on the sheet feeding paths and feed the sheet P. In addition, an arrow U in the figure indicates the upper direction of the image forming apparatus 10, an arrow F indicates the front direction thereof, and an arrow H indicates the lateral direction thereof.

The image forming apparatus 10 is provided with a first sheet feeding path 80 curved obliquely upward toward the front of the apparatus from the tip side (front side of the apparatus) of the sheet feed container 14 and a second sheet feeding path 82 curved obliquely upward toward the front of the apparatus from the tip side (tip side of the front of the apparatus in FIG. 1) of the sheet feed container 15. These sheet feeding paths converge in the front (in the lower portion) of a pair of positioning rollers 24 provided in the upper portion in relation to the sheet feed container 14.

Further, a cover 10A is openably attached to the front surface side of the image forming apparatus 10 using a hinge 10B provided in the lower portion of the apparatus as a rotation axis. A manual feed container 10C whose rotation axis is the same as that of the hinge 10B described above is provided on the front surface of the cover 10A, an input port 21 of sheet P provided in the cover 10A appears when the manual feed container 10C is opened. The input port 21 is a port of a third sheet feeding path 84 provided in the image forming apparatus 10 and the third sheet feeding path 84 is curved obliquely upward toward the behind of the apparatus from the input port 21.

A sheet feed roller 16 is provided directly above the tip side of the sheet feed container 14 so as to press the tip side of the upper surface of sheet P. A separation roller 18 pressed by the sheet feed roller 16 is provided on the front side of the apparatus in relation to the sheet feed roller 16. The sheet feed roller 16 has a configuration such that the sheet P is sent to the first sheet feeding path 80 by picking up the sheet P located on the top of the sheet feed container 14 and passing the sheet P between the sheet feed roller 16 and the separation roller 18. Further, the separation rollers 18 separate (separate the sheet P in a case where plural sheets of sheet is taken out) the sheet P taken out by the sheet feed roller 16.

Similarly, a sheet feed roller 17 is provided directly above the tip side of the sheet feed container 15 so as to press the tip side of the upper surface of sheet P. A separation roller 19 pressed by the sheet feed roller 17 is provided on the front side of the apparatus in relation to the sheet feed roller 17. The sheet feed roller 17 has a configuration such that the sheet P is sent to the second sheet feeding path 82 by picking up the sheet P located on the top of the sheet feed container 15 and passing the sheet P between the sheet feed roller 17 and the separation roller 19. Further, the separation roller 19 separates (separates the sheet P in a case where plural sheets of sheet are taken out) the sheet P taken out by the sheet feed roller 17.

Moreover, a pair of positioning rollers 25 are provided on the second sheet feeding path 82 and the positioning rollers 25 feed the sheet P sent to the second sheet feeding path 82 to the positioning rollers 24 side.

Moreover, the image forming apparatus 10 is provided with an image forming feeding path 86 that guides the sheet P sent from the positioning rollers 24 toward the fixing device 200 of the image forming unit 11, and the image forming feeding path 86 extends from the positioning rollers 24 to the fixing device 200 in the upper portion thereof.

The image forming feeding path 86 is provided with an endless feeding belt 26 that electrostatically adsorbs the sheet P and feeds the sheet P to the fixing device 200. The feeding belt 26 is supported while tension is applied thereto from a rotation roller 27 arranged in the upper portion thereof and from a rotation roller 29 arranged in the lower portion thereof. When one of the rotation roller 27 and the rotation roller 29 is rotary driven in one direction (counterclockwise direction in FIG. 1), the feeding belt 26 rotates (circulatory driven) in one direction (counterclockwise direction in FIG. 1).

A charging roller 32 that charges the surface of the feeding belt 26 and presses the sheet P to be electrostatically adsorbed to the feeding belt 26, to the feeding belt 26 is provided on the upstream side (in some cases, simply referred to as “upstream side”) of the image forming feeding path 86 of the feeding belt 26, adjacent to the feeding belt 26.

Further, plural process cartridges 28Y, 28M, 28C, and 28K corresponding to respective colors of yellow, magenta, cyan, and black are vertically arranged in series in a position facing the feeding belt 26 via the image forming feeding path 86 in the substantially vertical direction along the image forming feeding path 86. Moreover, the image forming unit 11 includes the process cartridges 28Y, 28M, 28C, and 28K, a transfer device 39, and the fixing device 200.

A photoreceptor drum 30 (an example of an image holding member) 30 that rotates in one direction (in the clockwise direction in FIG. 1) is provided in each of the process cartridges 28Y, 28M, 28C, and 28K. A charging roll (an example of a charging unit) 32 that charges the photoreceptor drum 30; an exposure device (an example of an electrostatic charge image forming unit) 34 that forms an electrostatic charge image on the photoreceptor drum 30 by exposing the charged photoreceptor drum 30; a developing roller (an example of a developing unit) 36 that develops the electrostatic charge image formed on the photoreceptor drum 30 by allowing toners of respective colors to be adhered to the electrostatic charge image formed on the photoreceptor drum 30; an erasing brush (an example of an erasing unit) 37 that erases the charge of the photoreceptor drum 30 after transfer; and a cleaning blade 38 (an example of a cleaning unit) that removes a toner remaining on the surface of the erased photoreceptor drum 30 are provided around the photoreceptor drum 30 in order from the upstream side in the rotation direction of the photoreceptor drum 30. Further, the toner removed from the surface of the photoreceptor drum 30 with the cleaning blade 38 is transported to one side by a toner transport ing member (auger) 35 and discharged to a toner collection container (not illustrated).

In addition, the charging roller 32 and the developing roller 36 are respectively provided in the respective process cartridges 28Y, 28M, 28C, and 28K. The respective process cartridges 28Y, 28M, 28C, and 28K are detachable from the apparatus to the left direction (in the front of the apparatus) (not illustrated).

In the exposure device 34, specifically, a semiconductor laser, a polygon mirror, an imaging lens, and a mirror are disposed in a housing and light from the semiconductor laser is deflected and scanned by the polygon mirror and applied to the photoreceptor drum 30 through the imaging lens and the mirror. In this manner, an electrostatic charge image in accordance with image information is formed on the photoreceptor drum 30.

The transfer device 39 that transfers a toner image formed on the photoreceptor drum 30 to the sheet P is provided in the inner peripheral side of the feeding belt 26 in the front direction of the photoreceptor drum 30.

The fixing device (an example of a fixing unit) 200 that fixes the transferred toner image to the sheet P is provided in the downstream side (in some cases, simply referred to as “downstream side”) of the image forming feeding path 86. The fixing device 200 includes a pair of rolls (an example of a fixing member) of a heating roller 62 and a pressure roller 64 pressed to the heating roller 62. By passing the sheet P to a nip portion 66 formed between the heating roller 62 and the pressure roller 64, the toner on the sheet P is melted and the transferred toner image (unfixed toner image) is fixed.

The image forming apparatus 10 is provided with a first sheet feeding path 88 that guides the sheet P subjected to a fixing treatment by the fixing device 200 to the discharge port 40. The discharge port 40 is provided with a discharge roller 210 that rotates using a driving motor (not illustrated) as a driving source which is normally rotatable or reversely rotatable and a pinch roller 214 (an example of a guide member) pressed to the lower surface side of the discharge roller 210. The pinch roller 214 is pressed to the discharge roller 210 by a torsion coil spring 240 (see FIG. 2) provided in the lower portion than the pinch roller 214 and co-rotates with the discharge roller 210. In this manner, when the image formation is finished, the sheet P passes the first sheet feeding path 88, is fed between the discharge roller 210 and the pinch roller 214, and is guided to the discharge portion 20 from the discharge port 40.

Further, a sheet sensor (not illustrated) is provided in the front of the discharge port 40 and the presence of the sheet P in the discharge port 40 is detected.

In a case where images are formed on both surfaces, the sheet P on which an image is formed on one surface is fed by the discharge roller 210 and the pinch roller 214, the discharge roller 210 is reversely rotated (specifically, the driving motor is reversely rotated) when the rear end portion of the sheet P approaches the nip portion of the discharge roller 210 and the pinch roller 214, and the sheet P is fed back to a second sheet feeding path 90 from the rear end portion. In the discharge roller 210, the timing at which the detection result of the sheet P detected by the sheet sensor is turned from presence to absence is set as a reversing timing. Further, the reversing timing of the discharge roller 210 is not particularly limited to the configuration and may be determined based on the size of the sheet P being fed and the feeding speed.

The second sheet feeding path 90 is provided in the image forming device 10, extends to the front side of the apparatus by passing through the upper portion than the first sheet feeding path 88, extends to the lower portion by passing through the front side of the apparatus than the image forming feeding path 86, and joins the third sheet feeding path 84 in the middle.

Plural (for example, two) pairs of feeding rollers 48 feeding the sheet P to the lower portion are arranged in the second sheet feeding path 90 and when images are formed on both surfaces, the sheet P on which an image is formed on one surface thereof is guided to the second sheet feeding path 90, fed to the lower side by the plural feeding rollers 48, and fed back to the positioning roller 24.

Next, the fixing device 200 will be described in detail. As illustrated in FIGS. 2 and 3, the fixing device 200 includes a housing 202. The housing 202 includes a side wall portion 202A attached to an inner wall surface (not illustrated) on one side of the image forming apparatus 10 in the lateral direction; a side wall portion 202B attached to another inner wall surface (not illustrated); and a connecting portion 202C connecting the lower portion sides of the side wall portion 202A and the side wall portion 202B. An upper surface 202D of the connecting portion 202C is positioned on the upper side of the heating roller 62, and the feeding path member 206 is attached to the upper surface 202D, on the rear side of the apparatus across the lateral direction of the apparatus. Further, a guide attaching portion (not illustrated) attaching a peeling guide 220 is formed (configured) of a standing wall 206A of the feeding path member 206 on the front side of the apparatus, the upper surface 202D of the connecting portion 202C, and inner wall surfaces of the respective side wall portion 202A and side wall portion 202B. Moreover, the above-described heating roller 62, the pressure roller 64, and the discharge roller 210 are rotatably supported by the side wall portion 202A and the side wall portion 202B.

The peeling guide 220 has a substantially triangular shape when seen from a side view (seen from the lateral direction of the apparatus) and is attached to the guide attaching portion (not illustrated) of the housing 202. Further, a tip 220A of the peeling guide 220 is in close to the heating roller 62 and peels the heated and fixed sheet P from the heating roller 62. Further, plural ribs 222 extending along the first sheet feeding path 88 are provided on the surface of the peeling guide 220 (surface of the apparatus on the front side) along with the axial direction of the heating roller 62 (that is, the lateral direction of the apparatus) in parallel and the surface of the rib 222 forms a feeding path surface 220B of the first sheet feeding path 88. Since the contact area between the sheet P passing through the first sheet feeding path 88 and the feeding path surface 220B of the peeling guide 220 is reduced due to the rib 222, the abrasion resistance is decreased, and the sheet P flows in the first sheet feeding path 88.

A stopper 224 is provided in the peeling guide 220. The stopper 224 is a plate and projects from the upper end portion of the rear wall surface of the peeling guide 220 to the discharge roller 210. Further, the above-described rib 222 is extended to the surface of the stopper 224 and a rib 222A is formed.

A rib 208 extending toward the discharge roller 210 side is provided on the upper surface of the feeding path member 206. Further, plural ribs 208 are arranged along with the lateral direction of the apparatus in parallel. In addition, the ribs 208 enter between the ribs 222 of the peeling guide 220 when seen from a front view (seen from the front side of the apparatus), and a surface made by the surface of the rib 222 and the surface of the rib 208 is flush in a side view.

A feeding path member 260 (hereinafter, referred to as a “paper chute 260”) that configures the first sheet feeding path 88 and the second sheet feeding path 90 is arranged in a position facing the peeling guide 220. The paper chute 260 includes a curved core 262 and side walls 264 are provided on both end portions of the core 262 in the lateral direction of the apparatus. A shaft portion 265 that rotatably supports the side wall 264 with respect to the housing 202 is provided on the side wall 264, on the front side of the apparatus. Moreover, plural ribs 266 having a substantially triangular shape in a side view are provided in the core 262 along with the lateral direction of the apparatus in parallel and cover the heating roller 62 and the pressure roller 64. Further, the surface of the rib 266 positioned on the upper surface of the core 262 is used as a feeding path surface 267 of the second sheet feeding path 90.

In the paper chute 260, the tip of the rib 266 enters between the ribs 222 of the peeling guide 220 using its own weight in a case where the sheet P is not present on the first sheet feeding path 88. Further, when the sheet P is fed from the nip portion 66 between the heating roller 62 and the pressure roller 64, the tip of the rib 266 of the paper chute 260 is pressed up, and the sheet P passes through the first sheet feeding path 88 to be sent to the discharge port 40. Further, when the sheet P is inverted, the discharge roller 210 is inverted and the sheet P is fed back onto the feeding path surface 267 of the paper chute 260.

A duplex unit 269 is arranged on the upper portion of the paper chute 260 such that the duplex unit 269 faces the paper chute 260. The duplex unit 269 is attached to the cover 10A and forms the second sheet feeding path 90 between the paper chute 260 and the cover 10A.

The discharge roller 210 is rotatably attached to the housing 202 by passing the shaft portion 210A through holes (not illustrated) respectively provided in the side wall portion 202A and the side wall portion 202B of the housing 202. At this time, the pinch roller 214 is pressed against the discharge roller 210 using the torsion coil spring 240.

In the fixing device 200 described above, the sheet P is peeled from the heating roller 62 by the peeling guide 220 after a toner image (unfixed toner image) transferred onto the sheet P is fixed by a pair of rolls of the heating roller 62 and the pressure roller 64. Next, the sheet P is sent to the discharge port 40 by a pair of rolls of the discharge roller 210 and the pinch roller 214. At this time, the sheet P is fed while a portion of the image (fixed image) is brought into a contact with each rib of the peeling guide 220, each rib of the feeding path member 206, and the pinch roller 214.

Process Cartridge/Toner Cartridge

A process cartridge according to the present exemplary embodiment will be described.

The process cartridge according to the present exemplary embodiment is a process cartridge that accommodates the electrostatic charge image developer according to the present exemplary embodiment, includes a developing unit developing an electrostatic charge image formed on the surface of the image holding member as a toner image by the electrostatic charge image developer, and is detachable from the image forming apparatus.

In addition, the process cartridge according to the present exemplary embodiment may have a configuration, which is not limited to the above-described configuration, including a developing device and at least one unit selected from other units such as an image holding member, a charging unit, an electrostatic charge image forming unit, and a transfer unit according to the necessity.

Next, a toner cartridge according to the present exemplary embodiment will be described.

The toner cartridge according to the present exemplary embodiment is a toner cartridge that accommodates the toner according to the present exemplary embodiment and is detachable from an image forming apparatus. The toner cartridge accommodates a toner for replenishment to be supplied to a developing unit provided in the image forming apparatus.

### EXAMPLES

Hereinafter, the present exemplary embodiment will be described in detail based on Examples, but the present exemplary embodiment is not limited to Examples below. Further, in the description below, “parts” and “%” are on a weight basis unless otherwise noted.

Preparation of Polyester Resin Dispersion

Polyester Resin Dispersion (PE1)
Ethylene glycol [manufactured by Wako Pure Chemical Industries, Ltd.]: 37 parts by weight
Neopentyl glycol [manufactured by Wako Pure Chemical Industries, Ltd.]: 65 parts by weight
1, 9-nonanediol [manufactured by Wako Pure Chemical Industries, Ltd.]: 32 parts by weight
Terephthalic acid [manufactured by Wako Pure Chemical Industries, Ltd.]: 96 parts by weight

The above-described monomers are put into a flask, the temperature therein is increased to 200° C. for 1 hour, and 1.2 parts of dibutyl tin oxide is put into the flask after it is confirmed that a reaction system is being stirred. Further, the temperature therein is increased to 240° C. for 6 hours from the same temperature while formed water is distilled, and a dehydration condensation reaction is continued at 240° C. for four hours, thereby obtaining a polyester resin (PE1) having an acid value of 9.4 mgKOH/g, a weight average molecular weight of 13000, and a glass transition temperature of 62° C.

Subsequently, the polyester resin (PE1) is transferred to Cavitron CD1010 (manufactured by Eurotech, Ltd.) in a melted state with a speed of 100 parts/min. Diluted ammonia water having a concentration of 0.37% which is obtained by diluting reagent ammonia water with ion exchange water is added to a separately prepared aqueous medium tank, and transferred to the Cavitron simultaneously with the polyester resin melt at a speed of 0.1 L/min while being heated to 120° C. using a heat exchanger. The Cavitron is operated under the conditions of a rotation speed of a rotator of 60 Hz and a pressure of 5 kg/cm², thereby obtaining a polyester resin dispersion (PE1) having a volume average particle diameter D50v of 160 nm and a solid content of 30%.

Preparation of Styrene Acrylic Acid Alkyl Copolymer Resin Particle Dispersion

Styrene Acrylic Acid Alkyl Copolymer Resin Particle Dispersion (SA1)
Styrene: 320 parts by weight
n-butyl acrylate: 80 parts by weight
Acrylic acid: 12 parts by weight
10-dodecanethiol: 2 parts by weight

A mixture obtained by mixing and dissolving the above-described components is emulsified and dispersed in a mixture obtained by dissolving 6 parts by weight of a non-ionic surfactant (Nonipol 400, manufactured by Sanyo Chemical Industries Co., Ltd.) and 10 parts by weight of an anionic surfactant (Neogen SC, manufactured by Dai-ichi Kogyo Seiyaku Co., Ltd.) in 550 parts by weight of ion exchange water in a flask, the mixture is slowly mixed for 10 minutes, and 50 parts by weight of ion exchange water in which 4 parts by weight of ammonium persulfate is dissolved is put into the mixture. After nitrogen substitution is performed, the content is heated to 70° C. using an oil bath while stirring the inside of the flask, and emulsion polymerization is continued for 4 hours. As a result, a styrene acrylic acid alkyl copolymer resin particle dispersion (SA1) having a volume average particle diameter D50v of 150 nm, a glass transition temperature Tg of 50° C., a weight average molecular weight Mw of 38000, and a solid content of 30% is obtained. Further, 15% of styrene oligomer with respect to a resin is generated in the dispersion.

Styrene Acrylic Acid Alkyl Copolymer Resin Particle Dispersion (SA2)

A styrene acrylic acid alkyl copolymer resin particle dispersion (SA2) having a solid content of 30% is obtained in the same manner as that of the styrene acrylic acid alkyl copolymer resin particle dispersion (SA1) except that the contents are heated to 60° C. using an oil bath and the time of emulsion polymerization is set to 1 hour and 30 minutes. The styrene acrylic acid alkyl copolymer resin particles in the dispersion have a volume average particle diameter D50v of 160 nm and a glass transition temperature Tg of 55° C. Further, 30% of styrene oligomer with respect to a resin is generated in the dispersion.

Styrene Acrylic Acid Alkyl Copolymer Resin Particle Dispersion (SA3)

A styrene acrylic acid alkyl copolymer resin particle dispersion (SA3) having a solid content of 30% is obtained in the same manner as that of the styrene acrylic acid alkyl copolymer resin particle dispersion (SA1) except that the contents are heated to 80° C. using an oil bath, 4 parts by weight of ammonium persulfate, which is a polymerization initiator, is additionally added thereto at the time point when emulsion polymerization is performed for 3 hours, and emulsion polymerization is further performed for 2 hours. The styrene acrylic acid alkyl copolymer resin particles in the dispersion have a volume average particle diameter D50v of 100 nm and a glass transition temperature Tg of 40° C. Further, 5% of styrene oligomer with respect to a resin is generated in the dispersion.

Styrene Acrylic Acid Alkyl Copolymer Resin Particle Dispersion (SA4)

A styrene acrylic acid alkyl copolymer resin particle dispersion (SA4) having a solid content of 30% is obtained in the same manner as that of the styrene acrylic acid alkyl copolymer resin particle dispersion (SA1) except that the contents are heated to 80° C. using an oil bath. The styrene acrylic acid alkyl copolymer resin particles in the dispersion have a volume average particle diameter D50v of 100 nm and a glass transition temperature Tg of 40° C. Further, 10% of styrene oligomer with respect to a resin is generated in the dispersion.

Styrene Acrylic Acid Alkyl Copolymer Resin Particle Dispersion (SA5)

A styrene acrylic acid alkyl copolymer resin particle dispersion (SA5) having a solid content of 30% is obtained in the same manner as that of the styrene acrylic acid alkyl copolymer resin particle dispersion (SA1) except that the contents are heated to 55° C. using an oil bath, 100 parts by weight of styrene is additionally added thereto at the time point when emulsion polymerization is performed for 1 hour, and emulsion polymerization is further performed for 1 hour. The styrene acrylic acid alkyl copolymer resin particles in the dispersion have a volume average particle diameter D50v of 200 nm and a glass transition temperature Tg of 60° C. Further, 60% of styrene oligomer with respect to a resin is generated in the dispersion.

Styrene Acrylic Acid Alkyl Copolymer Resin Particle Dispersion (SA6)

A styrene acrylic acid alkyl copolymer resin particle dispersion (SA6) having a solid content of 30% is obtained in the same manner as that of the styrene acrylic acid alkyl copolymer resin particle dispersion (SA1) except that the contents are heated to 60° C. using an oil bath and emulsion polymerization is performed for 1 hour. The styrene acrylic acid alkyl copolymer resin particles in the dispersion have a volume average particle diameter D50v of 160 nm and a glass transition temperature Tg of 55° C. Further, 35% by weight of a styrene oligomer with respect to a resin is generated in the dispersion.

Styrene Acrylic Acid Alkyl Copolymer Resin Particle Dispersion (SA7)

A styrene acrylic acid alkyl copolymer resin particle dispersion (SA7) having a solid content of 30% is obtained in the same manner as that of the styrene acrylic acid alkyl copolymer resin particle dispersion (SA1) except that the contents are heated to 85° C. using an oil bath, 4 parts by weight of ammonium persulfate, which is a polymerization initiator, is additionally added thereto at the time point when emulsion polymerization is performed for 3 hours, and emulsion polymerization is further performed for 2 hours. The styrene acrylic acid alkyl copolymer resin particles in the dispersion have a volume average particle diameter D50v of 100 nm and a glass transition temperature Tg of 40° C. Further, 2.5% by weight of a styrene oligomer with respect to a resin is generated in the dispersion.

Styrene Acrylic Acid Alkyl Copolymer Resin Particle Dispersion (SA8)

A styrene acrylic acid alkyl copolymer resin particle dispersion (SA8) having a solid content of 30% is obtained in the same manner as that of the styrene acrylic acid alkyl copolymer resin particle dispersion (SA1) except that the contents are heated to 85° C. using an oil bath, 5 parts by weight of ammonium persulfate, which is a polymerization initiator, is additionally added thereto at the time point when emulsion polymerization is performed for 3 hours, and emulsion polymerization is further performed for 3 hours. The styrene acrylic acid alkyl copolymer resin particles in the dispersion have a volume average particle diameter D50v of 100 nm and a glass transition temperature Tg of 40° C. Further, 1% by weight or less of a styrene oligomer with respect to a resin is generated and 99% or more of polymerized polystyrene with respect to a resin is generated in the dispersion.

Styrene Acrylic Acid Alkyl Copolymer Resin Particle Dispersion (SA9)

A styrene acrylic acid alkyl copolymer resin particle dispersion (SA9) having a solid content of 30% is obtained in the same manner as that of the styrene acrylic acid alkyl copolymer resin particle dispersion (SA1) except that 80 parts by weight of dimethylaminoethyl methacrylate is added in place of n-butyl acrylate. The styrene acrylic acid alkyl copolymer resin particles in the dispersion have a volume average particle diameter D50v of 150 nm and a glass transition temperature Tg of 50° C. Further, a styrene oligomer containing 80 atomic % of carbon and hydrogen with respect to the whole constituent elements is formed in the dispersion.

Styrene Acrylic Acid Alkyl Copolymer Resin Particle Dispersion (SA10)

A styrene acrylic acid alkyl copolymer resin particle dispersion (SA10) having a solid content of 30% is obtained in the same manner as that of the styrene acrylic acid alkyl copolymer resin particle dispersion (SA1) except that the contents are heated to 85° C. using an oil bath and emulsion polymerization is performed for 3 hours. The styrene acrylic acid alkyl copolymer resin particles in the dispersion have a volume average particle diameter D50v of 200 nm and a glass transition temperature Tg of 50° C. Further, a styrene oligomer whose maximum peak of molecular weight distribution shows 10000 is generated in the dispersion.

Further, in preparation of the styrene acrylic acid alkyl copolymer resin particle dispersion, characteristics of the generated styrene oligomer and polystyrene are listed in Table 1. Further, in Table 1, the characteristics of polystyrene are listed in columns of the styrene oligomer.

Preparation of Colorant Particle Dispersion

Preparation of Colorant Particle Dispersion (1)
Cyan pigment: 10 parts by weight [C.I.Pigment Blue 15:3, manufactured by Dainichiseika Color & Chemicals Mfg. Co., Ltd.]
Anionic surfactant: 2 parts by weight [Neogen SC, manufactured by Dai-ichi Kogyo Seiyaku Co., Ltd.]
Ion exchange water: 80 parts by weight

The above-described components are mixed with each other and dispersed using a high pressure impact type disperser Ultimizer [HJP30006, manufactured by SUGINO MACHINE LIMITED] for 1 hour, thereby obtaining a colorant particle dispersion (1) having a volume average particle diameter of 180 nm and a solid content of 20% by weight.

Preparation of Release Agent Particle Dispersion

Release Agent Particle Dispersion (1)
Polyethylene wax: 50 parts by weight [trade name: POLYWAX 725, manufactured by TOYO ADL CORPORATION, second endothermic peak temperature: 105° C.]
Anionic surfactant: 2 parts by weight [Neogen SC, manufactured by Dai-ichi Kogyo Seiyaku Co., Ltd.]
Ion exchange water: 200 parts by weight

The above-described components are heated at 120° C., mixed and dispersed using an Ultra-Turrax T50 (manufactured by IKA, Inc.), and subjected to a dispersion treatment using a pressure ejection type homogenizer, thereby obtaining a release agent particle dispersion (1) having a volume average particle diameter of 200 nm and a solid content of 20% by weight.

Release Agent Particle Dispersion (2)

A release agent particle dispersion (2) is obtained in the same manner as that of the release agent particle dispersion (1) except that a polyethylene wax [trade name: 800PF, manufactured by Mitsui Chemicals, Inc., maximum second endothermic peak temperature: 140° C.] is used as a release agent.

Release Agent Particle Dispersion (3)

A release agent particle dispersion (3) is obtained in the same manner as that of the release agent particle dispersion (1) except that a paraffin wax [trade name: HNP9, manufactured by Nippon Seiro Co., Ltd., maximum second endothermic peak temperature: 90° C.] is used as a release agent.

Release Agent Particle Dispersion (4)

A release agent particle dispersion (4) is obtained in the same manner as that of the release agent particle dispersion (1) except that an ester wax [trade name: WEP-5F, manufactured by NOF Co., Ltd., maximum second endothermic peak temperature: 90° C.] is used as a release agent.

### Example 1

### Preparation of Toner (1)

Polyester resin particle dispersion (PE1): 150 parts by weight
Styrene acrylic acid alkyl copolymer resin particle dispersion (SA1): 78 parts by weight
Colorant particle dispersion (1): 42 parts by weight
release agent particle dispersion (1): 20 parts by weight
Ion exchange water: 400 parts by weight

The above-described components are dispersed in a round stainless steel flask such that respective components are sufficiently mixed with one another using a homogenizer (Ultra-Turrax T50, manufactured by IKA, Inc.). Next, 7 parts by weight of a 10% aluminum sulfate aqueous solution is added to the dispersion, and the contents in the flask are stirred using a water bath. After the dispersed state is confirmed, the contents are stirred using a three-one motor (BLh300, manufactured by Shinto Scientific Co., Ltd.) at a stirring rotation speed of 150 rpm and heated under stirring to a temperature of 45° C. at a temperature raising rate of 0.5° C./min, and maintained at 45° C. for 60 minutes. Subsequently, 100 parts by weight of an additional polyester resin particle dispersion (PE1) is added thereto and then the contents are stirred for 60 minutes. When the obtained contents are observed using an optical microscope, it is confirmed that aggregated particles having a particle diameter of 4.0 μm are formed. 7 parts by weight of a 30% EDTA aqueous solution is added thereto and the pH thereof is adjusted to 7.5 with a 0.8M sodium hydroxide aqueous solution. Next, after the temperature is increased to 95° C., the contents are kept at 95° C. for 5 hours, cooled, filtered, sufficiently washed with ion exchange water, and dried, thereby obtaining toner particles (1) having a volume average particle diameter of 5.1 μm.

Subsequently, 3.3 parts by weight of hydrophobic silica particles (RY50, manufactured by Nippon Aerosil Co., Ltd.) are added to 100 parts by weight of the toner particles (1) as an external additive. Next, the mixture is mixed using a Henschel mixer at a peripheral speed of 30 m/s for 3 minutes. Subsequently, the mixture is sieved using a vibration sieve having a mesh of 45 μm, thereby obtaining a toner (1).

### Examples 2 to 8

Toners (2) to (8) are prepared in the same manner as that of Example 1 except that the kind and the amount of the styrene acrylic acid alkyl copolymer resin particle dispersion (written as a “StAc dispersion” in Table 1) and the kind and the amount of the release agent particle dispersion (written as a “WAX dispersion” in Table 1) are changed according to Table 1.

### Comparative Example 1

A toner (C1) is prepared in the same manner as that of Example 1 except that the styrene acrylic acid alkyl copolymer resin particle dispersion is not used and 12 parts by weight of a styrene oligomer having characteristics listed in columns of a styrene oligomer in Table 1 is used in place of the dispersion.

### Comparative Examples 2 to 4

Toners (C2) to (C4) are prepared in the same manner as that of Example 1 except that the kind and the amount of the styrene acrylic acid alkyl copolymer resin particle dispersion (written as a “StAc dispersion” in the table) and the kind and the amount of the release agent particle dispersion (written as a “WAX dispersion” in the table) are changed according to Table 1.

### Comparative Example 5

A toner (C5) is prepared in the same manner as that of Example 1 except that the styrene acrylic acid alkyl copolymer resin particle dispersion is not used and 2 parts by weight of a styrene monomer having characteristics listed in columns of the styrene oligomer in Table 1 is used in place of the dispersion.

### Example 9

A toner (9) is prepared in the same manner as that of Example 1 except that the kind and the amount of the styrene acrylic acid alkyl copolymer resin particle dispersion (written as a “StAc dispersion” in the table) and the kind and the amount of the release agent particle dispersion (written as a “WAX dispersion” in the table) are changed according to Table 1.

### Comparative Example 6

A toner (C6) is prepared in the same manner as that of Example 1 except that the styrene acrylic acid alkyl copolymer resin particle dispersion is not used and 2 parts by weight of an ester oligomer (epoxy ester 70PA, manufactured by Kyoei Chemical Industry Co., Ltd.) listed in columns of the styrene oligomer in Table 1 is used in place of the dispersion.

### Examples 10 to 12

Toners (10) to (12) are prepared in the same manner as that of Example 1 except that the kind and the amount of the styrene acrylic acid alkyl copolymer resin particle dispersion (written as a “StAc dispersion” in Table 1) and the kind and the amount of the release agent particle dispersion (written as a “WAX dispersion” in Table 1) are changed according to Table 1.

Evaluation

Preparation of Developer

8 parts by weight of the toners prepared as described above and 92 parts by weight of the carrier (A) described below are put into a V blender, stirred for 20 minutes, and sieved using a sieve having a mesh of 105 μm, thereby preparing a developer (1).

Preparation of Carrier (A)
Ferrite particles (volume average particle diameter: 50 μm): 100 parts by weight
Toluene: 100 parts by weight, 15 parts by weight
Styrene-methyl methacrylate copolymer (component molar ratio: 90/10): 2 parts by weight
Carbon black (R330, manufactured by Cabot Corporation): 0.25 parts by weight

First, a coating liquid in which the above-described components other than the ferrite particles are stirred using a stirrer for 10 minutes and dispersed is prepared, the coating liquid and ferrite particles are put into a vacuum degassing type kneader, the contents are stirred at 60° C. for 25 minutes, the pressure is reduced while the temperature therein is increased to perform degassing, and the contents are dried, thereby preparing a carrier A. The carrier (A) has a shape factor of 120, a true specific gravity of 4.4, a saturation magnetization of 63 emu/g, and a volume resistivity of 1000 Ω·cm at the time applying an electric field of 1000 V/cm.

Evaluation of Gloss Unevenness

A developing device of “Docu Print P450 ps” (manufactured by Fuji Xerox Co., Ltd.) is filled with the obtained developers. The device includes a fixing device having the same structure illustrated in FIGS. 2 and 3. Further, the distance between the fixing roll and the pinch roll in the fixing device is 0.06 m.

A solid image having an image density of 100% is formed on coated paper of A4 size (J coated paper, manufactured by Fuji Xerox Official Supply Co., Ltd.) in the entire region in the width direction intersecting with the sheet feed direction using the device. Further, the solid image is observed and the gloss unevenness is evaluated based on the following criteria.

Evaluation Criteria

Gloss values at 5 points are randomly measured in the range of 2 cm²×2 cm² and differences among respective gloss values at 5 points are evaluated. Further, the conditions of measuring gloss are as follows.

Gloss measuring device: Gloss METER Model GM-26D For75, manufactured by Murakami Color Research Institute, Inc., Angle: 75°, calibration plate: Value 98.6

A: Differences among gloss values are respectively in the range of 0 to 1

B: Differences among gloss values are respectively in the range of more than 1 to 2

C: Differences among gloss values are respectively in the range of more than 2 to 3

D: Differences among gloss values are respectively 4 or more

Evaluation of Charging Property

In regard to charging properties of toners prepared in the above, the charging amounts of externally added toners are evaluated in a low temperature and low humidity environment (room temperature of 10° C. and humidity of 20%). The evaluation criteria are as follows.

Evaluation Criteria

A: 40 μC/g to 50 μC/g

B: The lower limit is in the range of 35 μC/g to 40 μC/g and the upper limit is in the range of 50 μC/g to 55 μC/g

C: The lower limit is in the range of 30 μC/g to 35 μC/g and the upper limit is in the range of more than 55 μC/g to less than 60 μC/g

D: The lower limit is 30 μC/g or less and the upper limit is more than 60 μC/g

Hereinafter, the details of respective examples and evaluation results are collectively listed in Table 1.

TABLE 1

| | StAc dispersion | | | | | | | |
|---|---|---|---|---|---|---|---|---|
| | | | St oligomer | | | | | |
| | | | | Molecular weight | | | | |
| | | | | shown by | Weight | Content | | |
| | | | | maximum peak of | average | ratio of C | WAX dispersion | |
| | | Amount | | molecular weight | molecular | and H | | Amount |
| | No. | (parts) | Kind | distribution | weight | (atomic %) | No. | (parts) |
| Example 1 | SA1 | 78 | St Oligomer | 500 | 500 | 100 | 1 | 20 |
| Example 2 | SA2 | 78 | St Oligomer | 500 | 500 | 100 | 1 | 20 |
| Example 3 | SA3 | 78 | St Oligomer | 500 | 500 | 100 | 1 | 20 |
| Example 4 | SA4 | 78 | St Oligomer | 8000 | 8000 | 100 | 1 | 20 |
| Example 5 | SA5 | 117 | St Oligomer | 200 | 200 | 100 | 1 | 20 |
| Example 6 | SA1 | 19.5 | St Oligomer | 500 | 500 | 100 | 2 | 20 |
| Example 7 | SA1 | 78 | St Oligomer | 500 | 500 | 100 | 3 | 20 |
| Example 8 | SA1 | 78 | St Oligomer | 500 | 500 | 100 | 4 | 20 |
| Comparative | — | — | St Oligomer | 500 | 500 | 100 | 1 | 20 |
| Example 1 | | | | | | | | |
| Comparative | SA6 | 78 | St Oligomer | 500 | 500 | 100 | 1 | 20 |
| Example 2 | | | | | | | | |
| Comparative | SA7 | 78 | St Oligomer | 500 | 500 | 100 | 1 | 20 |
| Example 3 | | | | | | | | |
| Comparative | SA8 | 78 | Poly St | 500 | 500 | 100 | 1 | 20 |
| Example 4 | | | | | | | | |
| Comparative | — | — | St Monomer | 100 | 100 | 100 | 1 | 20 |
| Example 5 | | | | | | | | |
| Example 9 | SA9 | 78 | St Oligomer | 600 | 600 | 80 | 1 | 20 |
| Comparative | — | — | Es Oligomer | — | — | — | 1 | 20 |
| Example 6 | | | | | | | | |
| Example 10 | SA1 | 137 | St Oligomer | 500 | 500 | 100 | 1 | 20 |
| Example 11 | SA1 | 4 | St Oligomer | 500 | 500 | 100 | 1 | 20 |
| Example 12 | SA10 | 78 | St Oligomer | 10000 | 10000 | 100 | 1 | 20 |

| | WAX dispersion | | | | | |
|---|---|---|---|---|---|---|
| | Release agent | | | | | |
| | | Temperature | Components of toner | | | |
| | | of maximum | Content of | Content of | Evaluation | |
| | | second endo- | St oligomer | StAc resin | Gloss | Charging |
| | Kind | thermic peak | (% by weight) | (% by weight) | unevenness | property |
| Example 1 | PEW | 105 | 3 | 20 | A | A |
| Example 2 | PEW | 105 | 6 | 20 | A | A |
| Example 3 | PEW | 105 | 1 | 20 | B | A |
| Example 4 | PEW | 105 | 3 | 30 | A | B |
| Example 5 | PEW | 105 | 3 | 5 | B | B |
| Example 6 | PEW | 140 | 3 | 20 | C | C |
| Example 7 | PAW | 90 | 3 | 20 | B | C |
| Example 8 | EsW | 90 | 3 | 20 | C | C |
| Comparative | PEW | 105 | 3 | — | B | D |
| Example 1 | | | | | | |
| Comparative | PEW | 105 | 7 | 20 | D | A |
| Example 2 | | | | | | |
| Comparative | PEW | 105 | 0.5 | 20 | D | A |
| Example 3 | | | | | | |
| Comparative | PEW | 105 | — | 20 | D | B |
| Example 4 | | | | | | |
| Comparative | PEW | 105 | — | — | D | B |
| Example 5 | | | | | | |
| Example 9 | PEW | 105 | 3 | 20 | A | A |
| Comparative | PEW | 105 | — | — | D | B |
| Example 6 | | | | | | |
| Example 10 | PEW | 105 | 3 | 35 | C | C |
| Example 11 | PEW | 105 | 3 | 20 | C | C |
| Example 12 | PEW | 105 | 3 | 20 | C | C |

From the results described above, in the present examples, there is a tendency that gloss unevenness is prevented, compared to Comparative Examples.

Further, abbreviations in Table 1 are as follows.
St Oligomer: styrene oligomer
St monomer: styrene monomer
Es Oligomer: ester oligomer
poly St: polystyrene
PEW: polyester wax
PAW: paraffin wax
EsW: ester wax

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holding member;
a charging unit that charges a surface of the image holding member;
an electrostatic charge image forming unit that forms an electrostatic charge image on a charged surface of the image holding member;
a developing unit that stores a developer containing a toner and develops the electrostatic charge image formed on the surface of the image holding member so as to form a toner image;
a transfer member onto a surface of which the toner image is transferred;
a fixing member that fixes the toner image on a recording medium;
a guide member that guides the recording medium by being brought into contact with a portion of an image after passing through the fixing member and has a plural of ribs;
wherein the toner contains a binder resin, a colorant, and a release agent,
the binder resin comprising a polyester resin and a styrene-(meth)acrylic acid alkyl copolymer resin;
the release agent comprising
a hydrocarbon release agent comprising a wax selected from the group consisting of a polyethylene wax, a polypropylene wax, and a paraffin wax; and
an oligomer that comprises a styrene structure and whose content is in a range of 1% by weight to 6% by weight with respect to toner particles, and
the oligomer has a maximum peak of molecular weight distribution measured by gel filtration chromatogram in a range of molecular weight of 200 to 8000.

2. A toner cartridge that is detachable from an image forming apparatus comprising:
a container that contains a toner;
the toner comprises a binder resin, a colorant, and a release agent, wherein
the binder resin comprises a polyester resin and a styrene-(meth)acrylic acid alkyl copolymer resin;
the release agent comprises
a hydrocarbon release agent comprising a wax selected from the group consisting of a polyethylene wax, a polypropylene wax, and a paraffin wax; and
an oligomer that includes a styrene structure and whose content is in a range of 1% by weight to 6% by weight with respect to toner particles, and
the oligomer has a maximum peak of molecular weight distribution measured by gel filtration chromatogram in a range of molecular weight of 200 to 8000.

3. The image forming apparatus according to claim 1, wherein a weight average molecular weight (Mw) of the polyester resin is in a range of 5000 to 1000000.

4. The image forming apparatus according to claim 1, wherein a content of the styrene-(meth)acrylic acid alkyl copolymer resin is in a range of 5% by weight to 30% by weight with respect to the entirety of the binder resin.

5. The image forming apparatus according to claim 1, wherein a ratio of the styrene-(meth)acrylic acid alkyl copolymer resin to whole polymerization components of styrene monomers is in a range of 60% by weight to 90% by weight.

6. The image forming apparatus according to claim 1, wherein a ratio of the styrene-(meth)acrylic acid alkyl copolymer resin to whole polymerization components of (meth)acrylic acid alkyl ester is in a range of 10% by weight to 40% by weight.

7. The image forming apparatus according to claim 1, wherein a glass transition temperature of the styrene-(meth)acrylic acid alkyl copolymer resin is in a range of 40° C. to 70° C.

8. The image forming apparatus according to claim 1, wherein a weight average molecular weight of the styrene-(meth)acrylic acid alkyl copolymer resin is in a range of 20000 to 200000.

9. The image forming apparatus according to claim 1, wherein a molecular weight distribution Mw/Mn of the styrene(meth)acrylic acid alkyl copolymer resin is in a range of 1 to 10.

10. The image forming apparatus according to claim 1,
wherein the hydrocarbon release agent has an endothermic peak measured by differential scanning calorimetry, which undergoes a first temperature rise and fall and a second temperature rise, and
a maximum endothermic peak measured at the second temperature rise is in a range of 80° C. to 120° C.

11. The image forming apparatus according to claim 1, wherein a content of the hydrocarbon release agent is in a range of 1% by weight to 20% by weight with respect to the entirety of the toner particles.

12. The image forming apparatus according to claim 1, wherein the oligomer includes carbon and hydrogen in an amount of 95 atomic % or more with respect to whole constituent elements.
